(19) United States
(12) Patent Application Publication
(10) Pub. No.: US 2009/0249616 A1
(43) Pub. Date: Oct. 8, 2009

(54) METHOD FOR CONNECTING TWO ELECTRICALLY CONDUCTIVE COMPONENTS TO ONE ANOTHER

(75) Inventor: Karl Franz Fröschl, Herrnbaumgarten (AT)

Correspondence Address: YOUNG & THOMPSON, 209 Madison Street, Suite 500, ALEXANDRIA, VA, 22314, US

(73) Assignee: GEBAUER & GRILLER KABELWERKE GESELLSCHAFT M.B.H., POYSDORF (AT)

(21) Appl. No.: 12/303,145

(22) PCT Filed: Apr. 12, 2007
(86) PCT No.: PCT/AT2007/000166

§ 371 Date: Dec. 2, 2008

(30) Foreign Application Priority Data
Jun. 2, 2006 (AT) A 959/2006
Jan. 18, 2007 (AT) A 91/2007

(51) Int. Cl. B23P 19/00

(52) U.S. Cl. 29/745

(57) ABSTRACT

Process for connecting a first electrically conductive component in the form of a flexible electrical line having metal wires to a second electrically conductive metal component, e.g., a second electrical line or a connecting element. The free end of the flexible electrical line is inserted into a sleeve and is pressed with the latter; in addition, the end of the second electrically conductive component that is assigned to the flexible electrical line is inserted into the free end of the sleeve and is brought into contact on the flexible electrical line, and electrical current is run through these two components, by which their ends that lie on one another are melted together, whereby the sleeve is made from such a metal, which has a higher melting point compared to the metal or the metals of the two components that are to be connected to one another.

The invention in question relates to a process for connecting a first electrically conductive component in the form of a flexible electrical line having metal wires to a second electrically conductive metal component, e.g., a second electrical line or a connecting element.

The object is to prefabricate electrical lines in a motor vehicle that run from the battery to the starter to reduce to a great extent the installation costs in the laying of these lines. On the one hand, these electrical lines are made at specified lengths and, on the other hand, they are designed with curves and/or bends over their course to simplify decisively the laying thereof in this respect. To be able to implement such a premanufacturing, these lines have to have a corresponding rigidity, which is achieved in that the electrical line is designed with a one-piece metal strip or with a one-piece wire or rod.

Since, however, such electrical lines also have to contain flexible areas or since, notwithstanding their premanufacturing, the option must exist of performing a length comparison, the requirement exists to design these electrical lines with flexible line segments.

Because of the comparably low costs, such lines are preferably made from aluminum.

Based on its price-performance ratio in comparison to copper, aluminum is of interest even for lines in applications found outside of the automobile industry. One of these applications is in the area of elevator control technology. In this case, flat lines are used, which are employed in the elevator shaft as a connection between a stationary switchboard panel and the elevator car. With such lines, the tensile strength of the lines has to be adapted to the conveyor height of the elevator. Beyond a certain conveyor height, ordinary lines have to be reinforced by carrying elements in the form of fabric cords or steel cables. This is true in particular for those lines that are made from aluminum, since aluminum has a comparatively low tensile strength. For this reason, it is known to reinforce lines that are made from aluminum and that have a large number of wires by a wire that is made from a chromium-nickel alloy.

With flexible electrical lines, which are designed with a second electrically conductive component, such as with a rigid electrical line or with a connecting element, the requirement is to connect these two parts together, whereby contact resistances produced at the connecting point by this connection have to be avoided as much as possible.

It is known to connect rigid metal components to one another by means of resistance welding. This is possible because the two rigid metal components are brought into contact tightly and can be connected to one another by welding using an electrical current run through the latter. It has therefore not yet been possible to connect a flexible electrical line, designed with a large number of metal wires, to a rigid metal component by means of resistance welding, since the wires of the flexible electrical line cannot be brought into contact under pressure on the rigid component in the way that is necessary for the resistance welding.

The object of the invention in question is therefore to provide a process by which a flexible electrical line, which has a large number of wires, can also be connected by resistance welding to a second metal component, e.g., a one-piece metal conductor or a connecting element.

This is achieved according to the invention in that the free end of the flexible electrical line is inserted into a sleeve and is pressed with the latter, and in that in addition, the end of the second electrically conductive component that is assigned to the flexible electrical line is inserted into the free end of the sleeve and is brought into contact on the flexible electrical line, and in that electrical current is run through these two components, by which their ends that lie on one another are melted together, and the sleeve is made from such a metal, which has a higher melting point compared to the metal or the metals of the two components that are to be connected to one another.

Preferably, the two electrical components are brought into contact under pressure during the channeling of the current.

Preferably, the electrically conductive, metal second component is formed by an electrical line with an electrical conductor that is shaped in the form of a strip, rod or wire and that is connected to a flexible electrical line with a large number of wires. Also, the second electrically conductive component can be formed by a connecting element that is connected to a flexible electrical line with a large number of wires. In this case, the face of the second component that faces the first component can be designed in a profiled shape, whereby preferably the profiling is designed in a waffle pattern. Moreover, the flexible electrical line can have a large number of wires that are made of aluminum, which are reinforced by a wire that consists of a chromium-nickel alloy. In this case, the two electrically conductive components can be made from aluminum, from copper, from brass, or from aluminum, and a wire can be made from a chromium-nickel alloy. The sleeve can also be made from a steel sheet.

As soon as the two electrically conductive components have been welded together, insulation, in particular in the form of shrink film, is applied preferably over the connecting point.

The process according to the invention and an electrical line according to the invention are explained in more detail below based on three embodiments that are depicted in the drawing. Here:

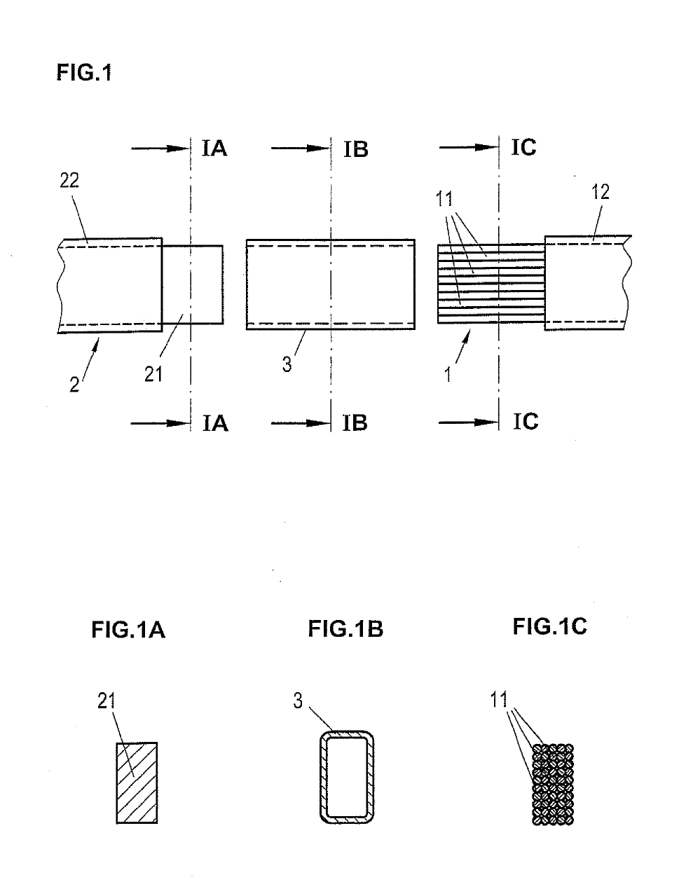

FIG. 1 shows two electrical components, which are connected to one another by resistance welding by means of the process according to the invention, in side view;

FIGS. 1A, 1B, 1C in each case show sections along the lines IA, IB, and IC of FIG. 1;

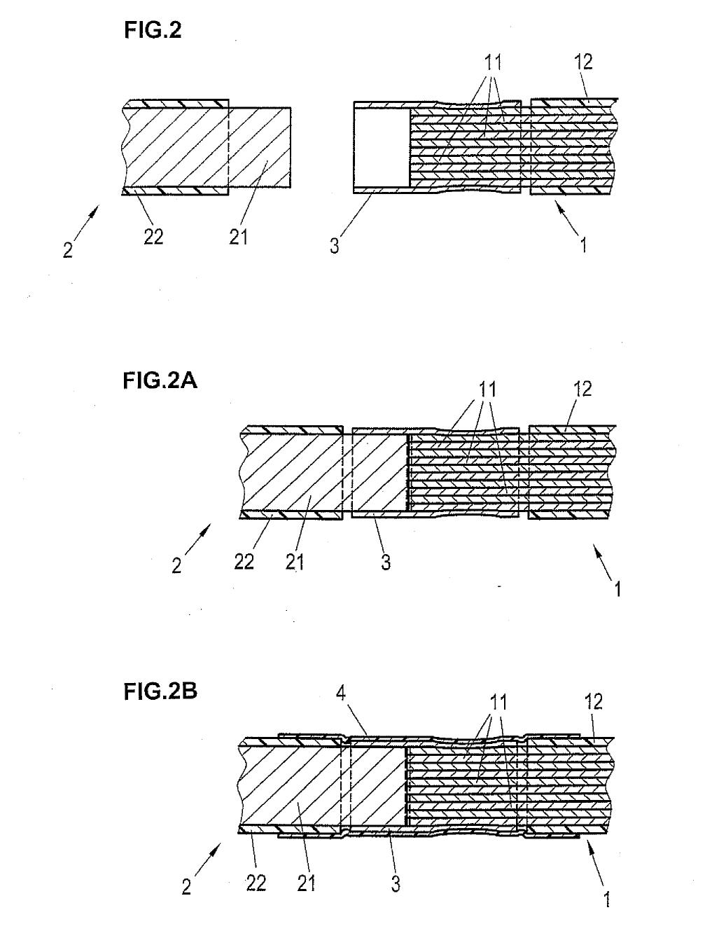

FIGS. 2, 2A, 2B show the components that are used during the process according to the invention in three successive process steps, in each case in axial section;

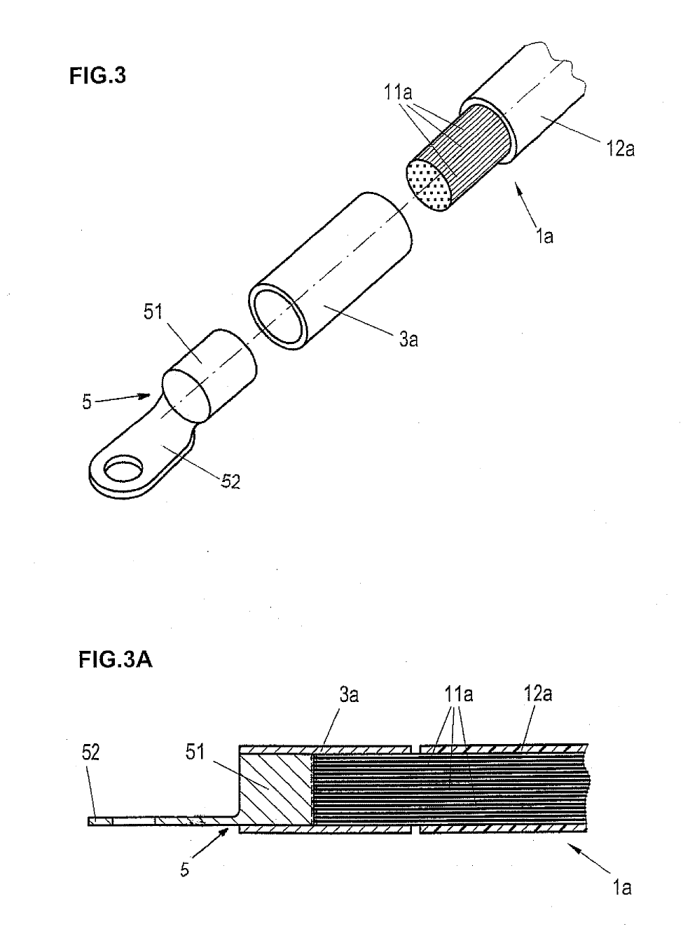

FIGS. 3, 3A show the components of a second embodiment, in which the process according to the invention is used;

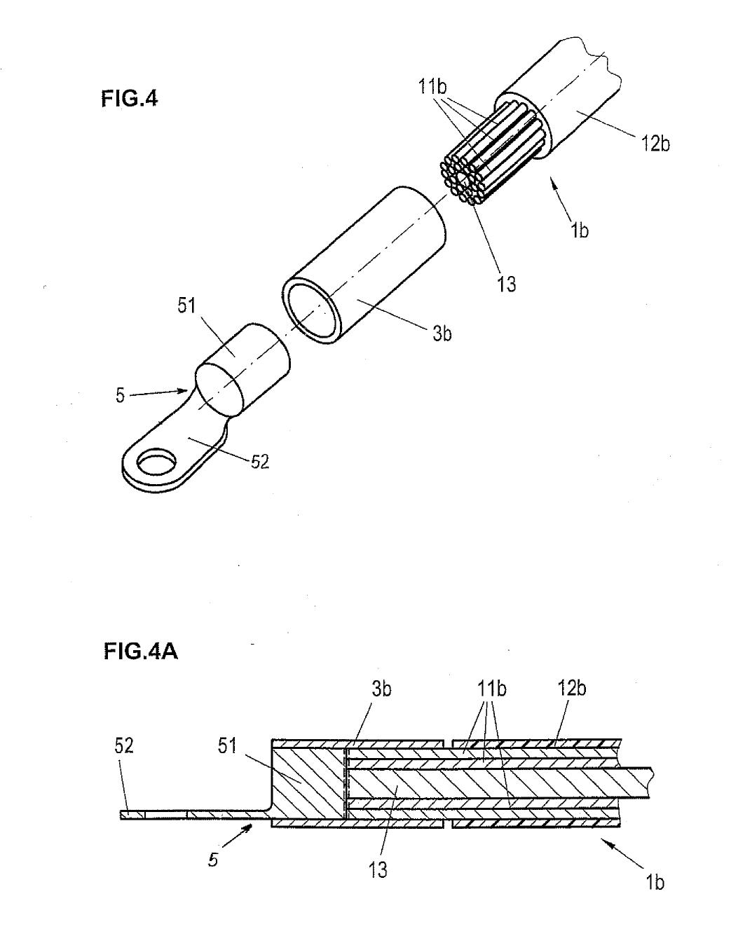

FIGS. 4, 4A show the components of a third embodiment, in which the process according to the invention is used; as well as

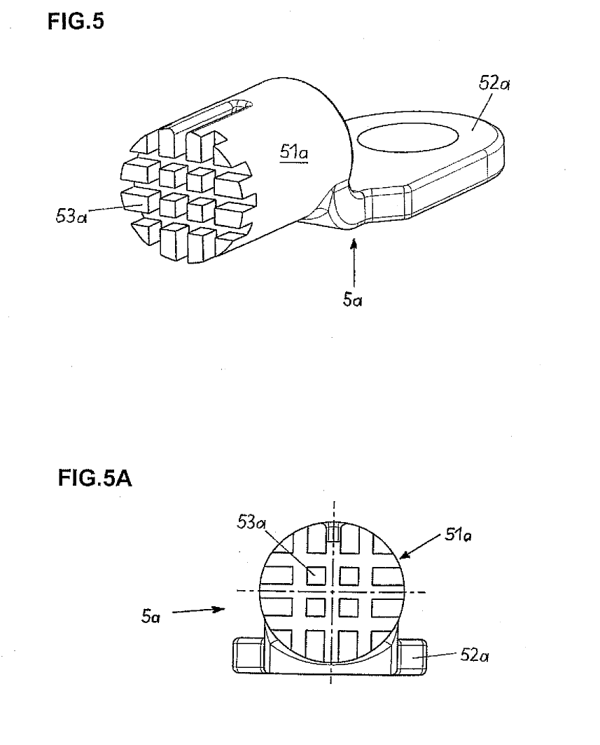

FIGS. 5, 5A show a connecting element, used in the process according to the invention, in axonometric view and in front view.

In FIGS. 1 and 1A to 1C, a flexible electrical line 1, which has a large number of metal wires 11 and which is designed with insulation 12, as well as an electrical line 2 with a one-piece, metal electrical conductor 21, which is also designed with insulation 22, are shown, and said two lines 1 and 2 are to be connected to one another. For this purpose, these two electrical lines 1 and 2 are stripped on the ends that are facing one another. To produce the compound, a metal sleeve 3 is provided, whose clear cross-section is roughly identical to the cross-section of the wires 11 and the conductor 21, which are to be connected to one another.

As is shown in FIG. 2, in a first process step, the stripped free end of the flexible line 1 that has a large number of wires 11 is moved into the sleeve 3 over at least two thirds of the length of the sleeve 3 into the latter, and the sleeve 3 is pressed with the wires 11. Subsequently, the free end of the conductor 21 is moved so far from the other side into the sleeve 3 that the faces of the conductor 21 and the wires 11 come into contact under pressure. In this connection, reference is made to the depiction of FIG. 2A. Then, electrical current is run through these two lines 1 and 2, by which based on the contact resistance that occurs in this respect within the sleeve 3, excessive temperatures occur so that the free ends of the lines 1 and 2 are melted together.

To make this mode of operation possible, the sleeve 3 has to be made from a metal whose melting point is above the melting point or the melting points of the metal or the metals from which the wires 11 and the conductor 21 are made. According to preferred embodiments, the wires 11 and the conductors 21 are made from aluminum or from copper, and the sleeve 3 is made from a steel sheet. Insofar as the metals that are used can be welded to one another, the wires 11 and the conductor 21 can be made from various metals. As soon as the wires 111 and the conductor 21 have been connected securely to one another, the connecting point is insulated by means of a shrink film 4 that is forced over the latter. For this purpose, reference is made to the depiction of FIG. 2B.

With this process, electrical lines, which are designed with rigid areas and in-between or subsequently with flexible areas, can thus be produced corresponding to the requirements in their use. Special requirements in laying electrical lines in motor vehicles can thus be met by such electrical lines.

In this case, it is relevant that with this process, a flexible electrical line 1 that has a large number of wires 11 can be connected to a rigid line 2 by means of welding. Moreover, the connecting point of this electrical line is protected from damage by bending by the metal sleeve 3 that is located at the connecting point. By this welding, the necessary electrical and mechanical connection of the two lines 1 and 2 to one another is achieved.

According to the second embodiment that is depicted in FIGS. 3 and 3A, a flexible line 1a, which has a large number of wires 11a and which is designed with insulation 12a, is connected, according to this process, to a connecting element 5, which is designed with a cylindrical part 51 and with a connecting tag 52. Also, in this case, the wires 11a of the stripped free end of the line 1a are inserted into a sleeve 3a from one side, the sleeve 3a is pressed with the wires 11a, the cylindrical part 51 of the connecting element 5 is inserted into the sleeve 3a from the other side, and the faces of these two components 1a and 5 are brought into contact under pressure. Then, electrical current is run through the line 1a and the connecting element 5, by which the latter are heated so greatly that they melt together.

This is another practical example that by means of a sleeve that is applied to a flexible electrical line with a large number of metal wires, this line can be connected permanently by resistance welding to another electrically conductive component.

According to the third embodiment depicted in FIGS. 4 and 4A, the flexible electrical line 1b consists of a large number of wires 11b, which are coated by insulation 12b and which are made from aluminum, and contains a middle wire 13, which consists of a metal that has a considerably better tensile strength than aluminum, e.g., a chromium-nickel alloy. Such a line 1b that is reinforced by an additional wire 13 is used in, for example, elevator shafts.

Also, in this case, the stripped free end of the line 1b is inserted from one side into a sleeve 3b and pressed with the sleeve 3b, the cylindrical part 51 of the connecting element 5 is inserted from the other side into the sleeve 3b, and the faces of these two components 1b and 5 are brought into contact under pressure. Then, electrical current is run through the line 1b and the connecting element 5, thus heating the latter up so much that they are melted together.

Thus, by means of the process according to the invention, a flexible electrical line that is made from aluminum, whose tensile strength is significantly increased by means of an additional wire, can also be connected to a connecting element by means of resistance welding, by which the requirements for, on the one hand, as low a contact resistance as possible and, on the other hand, a high level of mechanical strength are met in an optimal way.

With respect to the tensile strength, reference is made to the fact that aluminum has a tensile strength of about 80 N/mm², copper has a tensile strength of about 250 N/mm², and chromium-nickel alloys have a tensile strength of about 2000 N/mm².

Preferably, the face of the conductor 21 or the connecting element 5 that faces the wires 11, 11a or 11b is designed in a profiled shape. In this respect, the connection that is achieved by the welding of these two components is optimized with respect to a low contact resistance and to a scaling-up of the tensile strength.

In FIGS. 5 and 5A, a connecting element 5a with a cylindrical connecting part 51a and with a tag 52a is shown, whereby the connecting part 51a is designed on the side that faces away from the tag 52a with a profiling in the form of a waffle pattern 53a. Based on this profiling, an especially effective connection of the connecting element 5a to the subsequent electrical line is carried out, by which the mechanical strength of this connection is optimized, and the electrical contact resistance of this connection is minimized.

This also applies if the face of the conductor 21 is designed with such a profiling.

1. Process for connecting a first electrically conductive component in the form of a flexible electrical line (1) having metal wires (11) to a second electrically conductive metal component, e.g., a second electrical line (2) or a connecting element (5), characterized in that the free end of the flexible electrical line (1) is inserted into a sleeve (3) and is pressed with the latter, and in that in addition, the end of the second electrically conductive component (2, 5) that is assigned to the flexible electrical line (1) is inserted into the free end of the sleeve (3) and is brought into contact on the flexible electrical line (1), and in that electrical current is run through these two components (1; 2, 5), by which their ends that lie on one another are melted together, and the sleeve (3) is made from such a metal, which has a higher melting point compared to the metal or the metals of the two components (1; 2, 5) that are to be connected to one another.

2. Process according to claim 1, wherein the two electrically conductive components (1; 2, 5) are brought into contact under pressure while the electrical current is being run through.

3. Process according to claim 1, wherein the electrically conductive, metal second component (2) is formed by an electrical line with an electrical conductor (21) that is shaped in the form of a strip, rod or wire and that is connected to a flexible electrical line (1) with a large number of wires (11).

4. Process according to claim 1, wherein the second electrically conductive component is formed by a connecting element (5, 5a), which is connected with a flexible electrical line (1) to a large number of wires (11).

5. Process according to claim 1, wherein the face of the second component (2, 5, 5a) that faces the first component (1, 1a) is designed with a profiling.

6. Process according to claim 5, wherein the profiling is designed in a waffle pattern (51c).

7. Process according to claim 1, wherein the flexible line (1b) has a large number of wires (11b), which are reinforced by a wire (13) that is made from a chromium-nickel alloy.

8. Process according to claim 1, wherein the two electrically conductive components (1, 1a, 2) are made from aluminum, from copper or from brass, and/or from aluminum, and a wire is made from a chromium-nickel alloy, and wherein the sleeve (3, 3a) is made from a steel sheet.

9. Process according to claim 1, wherein insulation, in particular in the form of a shrink film (4), is applied over the connecting point.

10. Electrical line, in particular a battery cable for motor vehicles, which is designed with at least one rigid area and with at least one flexible area, whereby the ends of the metal components (1, 1a, 1b, 2, 5) that lie on one another are connected to one another by resistance welding with use of a metal sleeve (3, 3a) that surrounds the connecting point.

11. Process according to claim 2, wherein the electrically conductive, metal second component (2) is formed by an electrical line with an electrical conductor (21) that is shaped in the form of a strip, rod or wire and that is connected to a flexible electrical line (1) with a large number of wires (11).
